(19) United States
(12) Patent Application Publication
(10) Pub. No.: US 2010/0000867 A1
(43) Pub. Date: Jan. 7, 2010

(54) DEVICE FOR COALESCING FLUIDS

(75) Inventors: Pål J. Nilsen, Bodalen (NO); Erik Bjorklund, Oslo (NO)

Correspondence Address: VENABLE LLP, P.O. BOX 34385, WASHINGTON, DC, 20043-9998, US

(73) Assignee: Aibel AS, Billingstad (NO)

(21) Appl. No.: 12/373,297

(22) PCT Filed: Jul. 3, 2007
(86) PCT No.: PCT/IB07/01823

§ 371 Date: Jan. 12, 2009

(30) Foreign Application Priority Data
Jul. 11, 2006 (NO) 20063219

(51) Int. Cl. B03C 7/06

(52) U.S. Cl. 204/666; 204/660

(57) ABSTRACT

A device for coalescing an emulsion component in an emulsion including a mixture of at least two different fluid components by an electric field applied to the emulsion. The device includes at least one electrostatic coalescer element. The coalescer element includes a tubular channel made of an electrically insulating material, a first electrode mounted on one side of the tubular channel, and a second electrode mounted on the other side of the tubular channel, a first end wall including a first opening adapted to receive a first end of the tubular channel, and a second end wall including a corresponding second opening adapted to receive a second end of the tubular channel. The walls together with the tubular channel isolate the emulsion from the electrodes.

### FIELD OF THE INVENTION

The present invention relates to an electrically energized device for use in the separation of a first fluid emulsified in a second fluid with different dielectric properties. The invention may have a wide field of use, but it is particularly useful in the oil industry for removing water from a stream of oil and/or gas produced from a well.

### BACKGROUND OF THE INVENTION

Fluids produced from an underground formation are usually a mixture of water, oil and gas (and sand), in which at least some of the water is emulsified in the oil. This mixture of fluids is usually separated into its components downstream of the wellhead, in order to be deliverable to pipe lines for further distribution. A possible method for performing such a separation is to use a multi-stage process involving a number of gravity separator tanks in succession. In order to improve the action of a gravity settling tank, the tank may be complemented with electrostatic coalescer devices.

A particularly advantageous coalescing device is described in Norwegian patent NO 316109, owned by the present applicant. This device includes a number of electrostatic coalescer elements which are arranged in a matrix covering a cross sectional area of a separator vessel. The well fluids are forced to flow through this matrix of coalescer elements, which then acts as a flow straightener in addition to provide a coalescing effect. Each element is provided with insulated electrodes for applying an electrical field to the passing fluids. The insulated arrangement of electrodes allows the device to work effectively under very different conditions, such as the vessel going nearly dry (e.g. high gas content in the produced fluids), or the vessel being nearly flooded with salt water. Another benefit of this device is that the coalescer elements are arranged in handy modules, which are moulded, allowing the device to be retrofitted easily to existing separator vessels.

The fluid channels of the coalescer elements described in NO 316109 were moulded in an epoxy resin. However, epoxy resins are organic materials that degrade with time in harsh environments, e.g. crude oil processing. The degradation affects the electrical properties of the elements, and may reduce the lifetime of the device. The degradation is significantly enhanced in high temperature processing. This calls for replacements of the device at certain intervals (more often at high temperatures). Replacing the device is not always possible. Sometimes it is not economically acceptable, or as in a subsea application, it is not physically feasible. To increase the efficiency of the device, higher field strengths have to be applied. This can cause partial discharges in the emulsion and on the device itself. Organic materials have a limited resistance towards partial discharges, which can limit the applied electric field in the device.

The coalescer modules described in NO 316109 are also costly to manufacture. This is mainly due to the casting moulds. Moulds are costly and a new mould must be made for each design. This also limits the number of workshops that may manufacture the modules, i.e. the production is limited to workshops that can manufacture moulding forms.

### SUMMARY OF THE INVENTION

It is the main object of the present invention to provide a coalescer device that can operate at very high temperatures with an acceptable lifetime.

Another object is to provide a device that can be manufactured at any well equipped workshop in a cost effective way.

These and other objects are achieved according to the present invention by a device for coalescing an emulsion component in an emulsion comprising a mixture of at least two different fluid components by means of an electric field applied to the emulsion, the device including at least one electrostatic coalescer element. The present invention is characterized in that the coalescer element includes a tubular channel made of an electrically insulating material, a first electrode mounted on one side of the tubular channel, a second electrode mounted on the other side of the tubular channel, a first end wall including a first opening adapted to receive a first end of the tubular channel, a second end wall including a corresponding second opening adapted to receive a second end of the tubular channel, in which said walls together with the tubular channel isolate the emulsion from the electrodes.

According to a preferred embodiment of the present invention, the tubular channel is made of a ceramic material, where the tube-shaped object is mounted in a box of stainless steel that comprises a coalescer device. The use of materials such as ceramics has several advantages apart from the ability to withstand high temperatures. Ceramics are well known for their chemical resistance and stable electrical properties. In addition, the ceramics have a very high arc resistance, which allows the use of very high field strengths.

According to other preferred embodiments of the present invention, the tubular channel is made of glass or thermoplastic material.

According to another preferred embodiment, the tubular channel is mounted in a box with at least one side wall, said first end wall and said second end wall.

According to a preferred embodiment, the box is made of steel, preferably stainless steel.

According to another preferred embodiment, the tubular channel includes bushings of steel, preferably stainless steel, attached to each end of the tubular channel.

According to another preferred embodiment, the tubular channel includes first gaskets providing fluid-tight connections between the bushings and the tubular channel.

According to other preferred embodiments, the first gaskets are expansion gaskets or compression gaskets, wherein the gaskets preferably are made of steel.

According to another preferred embodiment, the first gaskets are PFTE sealing rings.

According to another preferred embodiment, the bushings are shrink-fitted onto the tubular channel.

According to another preferred embodiment, the bushings are glued onto the tubular channel.

According to another preferred embodiment, each bushing and/or the tubular channel includes a grooved part.

According to another preferred embodiment, each bushing includes a threaded part adapted to mount the bushing to the first or second end wall.

According to another preferred embodiment, a second gasket is provided between each bushing and the first or second end wall.

According to another preferred embodiment, each tubular channel is mounted to the first and second end walls by welding.

According to another preferred embodiment, the box includes a transformer transforming a low-voltage supply voltage into a high voltage for driving the coalescer elements.

According to another preferred embodiment, the coalescer elements are energized from a power supply external to said box.

According to another preferred embodiment, the box is filled with insulating oil.

According to another preferred embodiment, a layer is provided on said tubular channel, said layer having low permittivity, is electrically insulating and is able to withstand a strong electric field.

According to another preferred embodiment, said layer is made from PFTE.

According to another preferred embodiment, the box is filled with SF₆.

According to another preferred embodiment, the box is pressurized.

According to another preferred embodiment, expansion bellows are installed in the box equalizing the pressures inside and outside said box.

According to another preferred embodiment, the first end wall includes a plurality of first openings each adapted to receive a first end of a tubular channel, the second end wall including a corresponding plurality of second openings each adapted to receive a second end of a tubular channel.

According to yet another preferred embodiment, the tubular channel or channels are mounted substantially horizontal.

Further advantages as well as advantageous features of the present invention will appear from the following description of preferred embodiments cited as examples.

### BRIEF DESCRIPTION OF THE DRAWINGS

The present invention will be described in more detail with reference to the appended drawings, in which:

FIG. 1a-e are schematic views of how an embodiment according to the present invention may be assembled,

FIG. 2-6 show various embodiments of how a coalescer element may be mounted (directly or indirectly) to an end wall according to the present invention,

FIG. 7 shows a separator vessel with a coalescer device covering the whole cross section of the vessel according to an embodiment of the present invention,

FIG. 8 shows a separator with a coalescer device, the device partly covering the cross section of the vessel according to another embodiment of the present invention.

### DETAILED DESCRIPTION ACCORDING TO PREFERRED EMBODIMENTS OF THE INVENTION

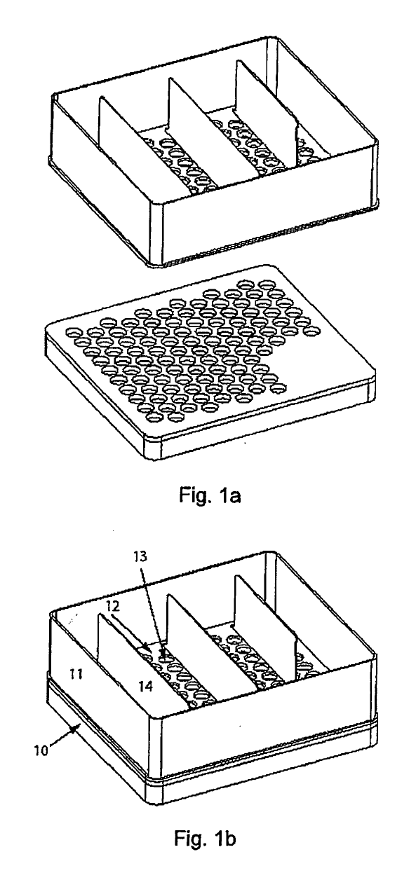

FIG. 1 shows the various components forming a coalescer module designed according to the present invention, and how they are assembled.

As shown in FIG. 1a, the module includes an installation plate 10 and a coalescer box mounted on said installation plate 10. The box includes a first end plate 12 and a wall 11. The installation plate and box may be made of stainless steel, e.g. 3 mm of thickness. As shown in FIG. 1b, the first end plate 12 includes a plurality of first mounting holes 13 and a number of first electrode plates 14 (grounded electrodes). As shown in FIG. 1c, in each first mounting hole 13 there will be mounted a coalescer tube 15 forming a channel through which the fluid mixture is intended to pass. In one part, such as a corner, of the box there is arranged a transformer 18. The transformer includes a primary winding connected to a primary source of electricity outside the coalescer, and a secondary high voltage winding connected to high voltage connectors (not shown). The high voltage connectors hold a number of second electrode plates 17 (high voltage electrodes). The high voltage connectors and second electrode plates 17 are insulated from the box and the first electrode plates 14.

As shown in FIG. 1d, a second end plate 19 with second mounting holes 110 and third electrode plates 111 (grounded electrodes) is mounted on top of the box closing the module. The second mounting holes 110 will accommodate the other end of the coalescer tubes 1. The coalescer tubes 15 are mounted fluid tight in the first and second end plates forming a fluid tight chamber inside the box.

The third electrode plates 111 together with the first electrode plates 14 form one set of electrode plates passing between every second row of coalescer tubes 15. The corresponding set of electrodes (the corresponding other electrodes in each pair) are formed by the second electrode plates 17. The electrode plates are energized by the transformer 18. By security reasons the box is grounded when mounted in the settling tank, and the second electrodes placed at full potential. The interior of the coalescer module may be filled with insulating oil or insulating gas, such as SF₆. The internal pressure may be balanced with the outside by means of expansion bellows (not shown). This means that there will be no pressure difference acting on the seal between the coalescer tubes and the mounting holes. However, the interior of the box may also be pressurized, as the insulating strength of the gas can increase with increasing pressure. Strong electric fields will arise in the area adjacent to the tube if the coalescer channels become filled with salt water. Thus, a spacer (not shown) may with advantage be provided between the tube and insulting oil. This spacer should be electric insulating, have lower permittivity than the oil, and have high electric strength. The low permittivity will move the field's top value into the spacer that will withstand the high field. A suitable material for this spacer is PFTE, although other materials may also be used. The spacer could be provided as a layer or mantle on the tube.

The tubes 15 may be made from any suitable insulating material including ceramics, glass or thermoplastic (the latter typically for low pressure/low temperature applications). There are many ceramic materials that may be suitable for this application. Ceramics are a wide group of materials. Suitable varieties include ceramics fired at high temperatures, such as classic feldspar ceramics (china), aluminium nitride ceramics or composite ceramics. There are also many suitable varieties of glass including common sodium glasses and hardened boron silicate glasses such as Pyrex®.

FIG. 1e shows the assembled coalescer module. A connector opening 112 is included in the second end plate through which power is supplied to the transformer.

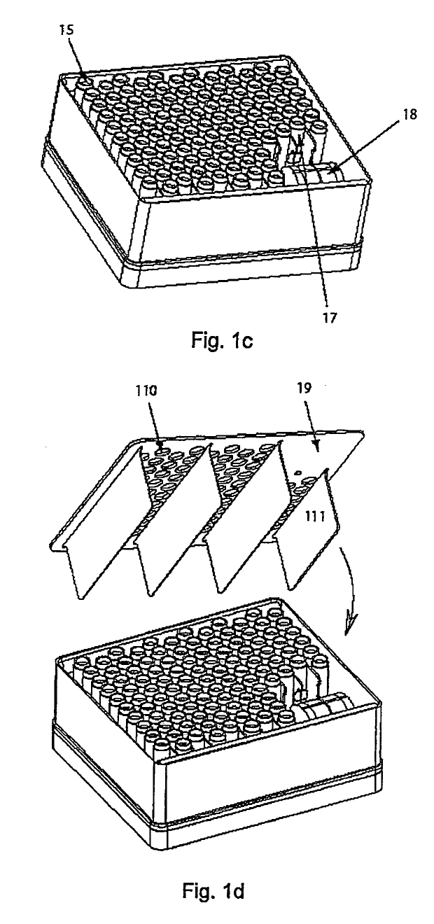

FIG. 2 shows how each ceramic tube may be mounted in the first or second end plates according to an embodiment of the invention. The tube 21 is mounted in a bushing 24, and is protruding through the end plate 22. A first expandable gasket 26 is located between the bushing 24 and tube 21 preventing fluid from entering the interior of the coalescer device. A tapered ring 27 is arranged to exert pressure on the first gasket urging it against the tube.

The tapered ring is brought under pressure through an annular nut 25 that is screwed into an outer part of the bushing with corresponding threads. The bushing 24 has an inner threaded part 28 and is screwed into corresponding threads in the end plate 22. A second gasket 23 prevents influx of fluids between end plate and bushing.

All components in this particular embodiment of the invention may preferable be made of stainless steel. This is an embodiment particularly suited for high pressure and temperature applications. This way of mounting the tube allows for large differences in the length of the tube, i.e. large tolerances in length.

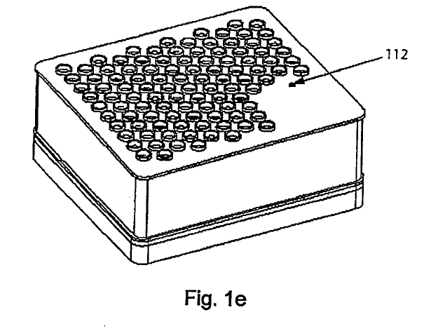

FIG. 3 shows another embodiment according to the invention. This embodiment uses a so-called compressible gasket including a wedge ring 36 which is urged against a compression gasket 37. The wedge ring 36 and compression gasket 37 are pressed together by ring nut 35. The tube 31 and bushing 34 are mounted in the end plate 32 in the same way as in FIG. 2. Also the components 32-37 of this embodiment may be made in stainless steel and used for high pressure and/or temperature conditions.

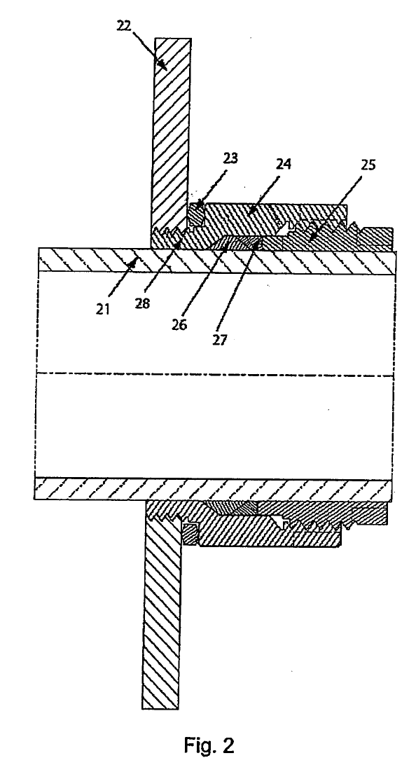

FIG. 4 shows an embodiment intended for less high pressure conditions. The tube 41 is also in this embodiment mounted in a bushing 44. The path between tube and bushing is made fluid tight with a PFTE (e.g. Teflon®) seal ring 46. The seal ring is designed as a normal oil processing seal ring with an annular expansion spring 47. The seal ring is mounted inside the bushing 44 by means of a ring nut 45 compressing it towards an abutment in the bushing 44. The bushing is intended to be fastened to the end plate 42 by welding. The welding seam 48 will then seal off the interior of the device from outside fluids. The bushing could also be threaded and fixed to the end plate 42 with a nut that includes a seal ring.

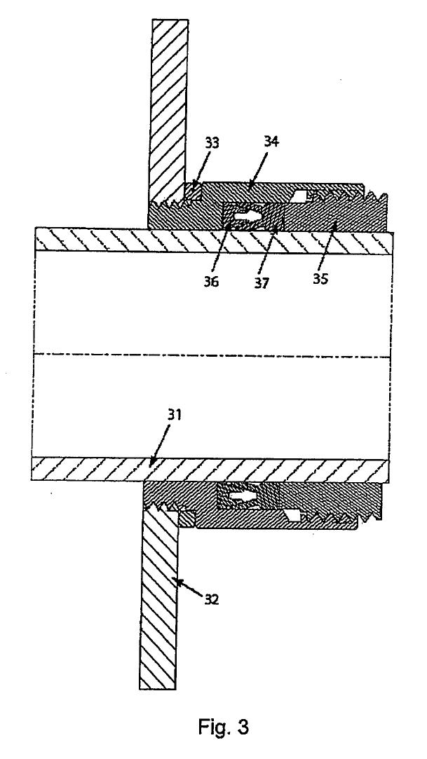

In FIG. 5 is shown an embodiment in which bushings 59 are shrink fitted onto the tube 51. Shrink fitting means that the bushing is heated before it is mounted on the tube. When cooled, it will contract and grip the tube. The bushing includes an abutment 510 preventing the tube from moving inside the bushing. The abutment 510 has rounded corners to prevent local stress conditions. A small slit 511 provides some axial expansion space for the tube 51, and will take up production tolerances. The bushings are intended to be welded to the end plates. A portion 512 of the bushing 59 has reduced diameter in order to allow the coalescer elements to be mounted tightly together while still providing sufficient space for the welding seams. The bushings are preferably made of stainless steel.

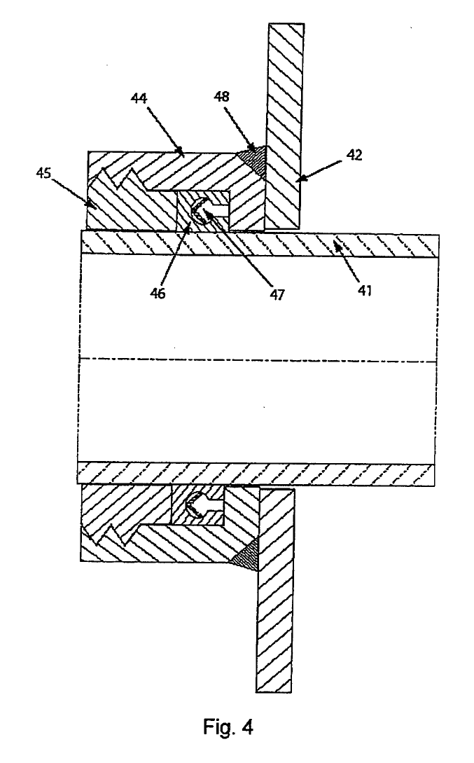

FIG. 6 illustrates still another embodiment. This embodiment is similar to the one shown in FIG. 5, but the bushings are not shrink fitted on the tube. Instead, the bushings 69 are glued onto the tube 61. A small annular slit 613 is provided between the tube and each bushing, the slit being filled with glue. The glue in question may be an epoxy resin or silicon for normal temperature applications. Silicate glue may be used when higher temperatures are expected (up to about 200° C.). The inside of each bushing 69 and/or the outside of the tube 61 may be provided with grooves for the glue. This embodiment has an advantage over the previous embodiment, in that heating of the bushings are avoided, when they are mounted on the tube. The bushings are preferably made of stainless steel.

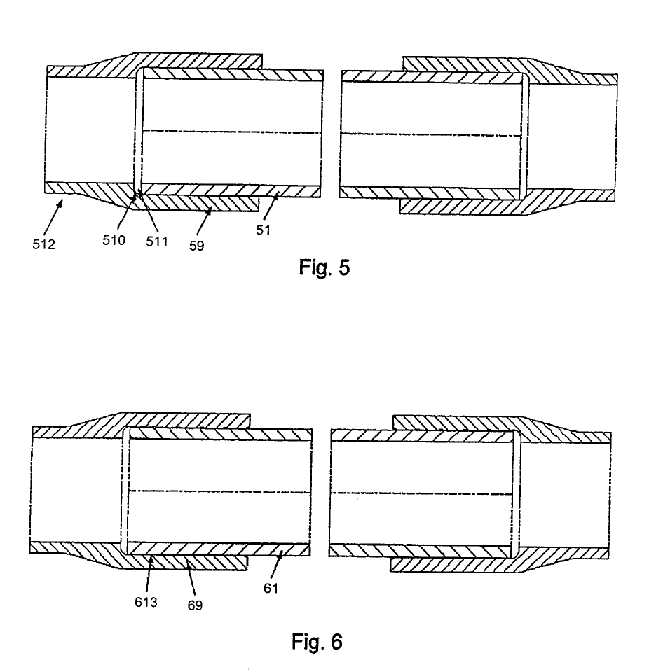

FIG. 7 shows the inventive coalescer device installed in a separator tank or in a pipe section 70. The upper figure shows a cross section through the tank or pipe 70. The lower figure shows a longitudinal section along the line A-A. The large arrow shows the flow direction of fluids, while 71 designates the electrodes interleaved with rows of coalescer channels (shown as broken lines in the upper figure). The coalescer device may cover the whole cross section of the tank/pipe forcing all the fluids to pass through the coalescer channels. The coalescer device may be designed as a single unit covering the whole section of the separator tank/pipe. However, in the case of a separator tank it is preferred to design the coalescer as smaller modules that may be brought inside the separator tank through a small entrance, such as a manway, and there assembled to a full coalescer unit. This eases retrofitting in existing separator tanks.

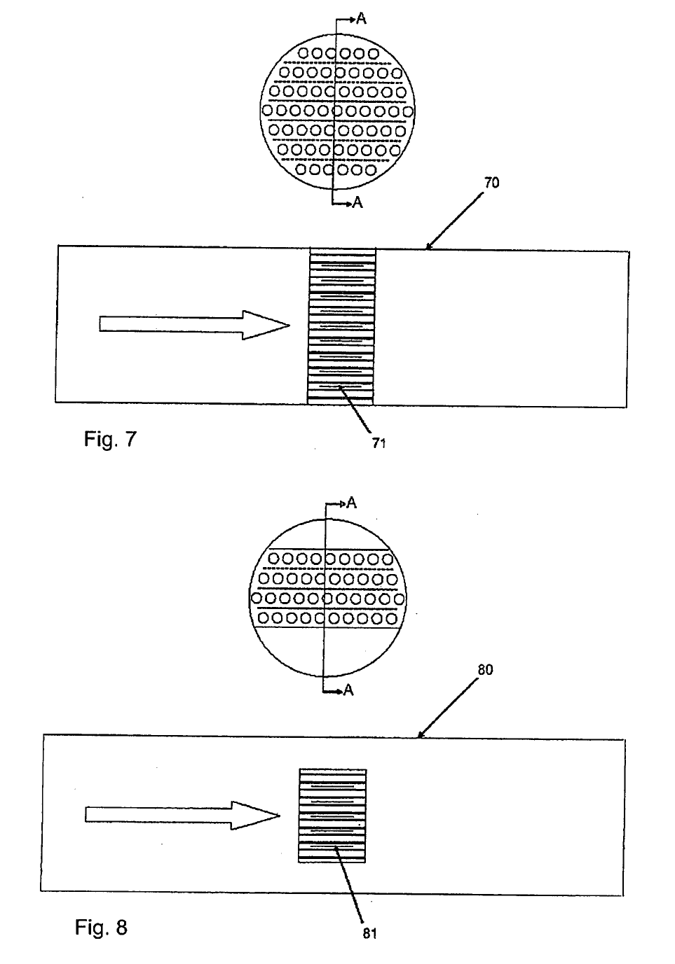

FIG. 8 shows a separator tank/pipe section in which the coalescer device may cover only a part of the cross section. Thus, only a part of the fluids will pass through the coalescer device and become influenced by the field created by the electrodes 81. This part may be an emulsion layer between the water and oil phase. Thus, only the mixed fluids are coalesced, while the rest may pass unhindered.

The coalescer tubes are generally mounted in a horizontal position or nearly horizontal as it may be desirable to let the tubes decline slightly to avoid accumulation of components to be separated, such as water. As shown in FIG. 1, each module includes a separate transformer. However, the transformer occupies space that better could be used to provide more coalescer tubes. Thus, it may be desirable to exclude the transformer in the modules, and rather feed the modules from a common power supply, possibly located outside the separator tank.

A difference between the present invention and the prior art coalescer in NO 316109, is that in the earlier construction of epoxy, the electrodes are isolated from the fluid, which means that the insulating material is in direct contact with the electrodes, whereas in the present invention it is the fluid that is isolated. This means that the electrodes may be free-standing.

A benefit of the inventive coalescer device is that it is geometrically very flexible. It can cover a whole separator cross section area/pipe section, as illustrated in FIG. 7, or it can be made into smaller modules of any form. The tubular channels can easily be made longer than the ones disclosed in NO 316109. Another benefit is that the coalescer device is not subjected to any moulding. The components of a coalescer unit or module may thus be made at different sites or locations allowing more parallel production. Furthermore, the materials have a higher robustness; have a high arc resistance, are chemically inert and have no water absorption at high temperatures. The high arc resistance means that higher field strengths may be applied.

The present invention is of course not in any way restricted to the embodiments described above. On the contrary, many possibilities to modifications thereof will be apparent to a person with ordinary skill in the art without departing from the basic idea of the invention such as defined in the appended claims.

1. A device for coalescing an emulsion component in an emulsion comprising a mixture of at least two different fluid components by an electric field applied to the emulsion, the device comprising:
at least one electrostatic coalescer element, the coalescer element comprising a tubular channel comprising an electrically insulating material, a first electrode operatively connected to one side of the tubular channel, a second electrode mounted on another side of the tubular channel, a first end wall including a first opening adapted to receive a first end of the tubular channel, a second end wall including a corresponding second opening adapted to receive a second end of the tubular channel, in which said walls together with the tubular channel isolate the emulsion from the electrodes.

2. The device according to claim 1, wherein the tubular channel comprises ceramic material.

3. The device according to claim 1, wherein the tubular channel comprises glass.

4. The device according to claim 1, wherein the tubular channel comprises thermoplastic material.

5. The device according to claim 1, wherein the tubular channel is mounted in a box with at least one side wall, said first end wall and said second end wall.

6. The device according to claim 5, wherein the box comprises steel.

7. The device according to claim 1, wherein the tubular channel comprises steel bushings attached to each end of the tubular channel.

8. The device according to claim 7, wherein the tubular channel comprises first gaskets providing fluid-tight connections between the bushings and the tubular channel.

9. The device according to claim 8, wherein the first gaskets are expansion gaskets.

10. The device according to claim 8, wherein the first gaskets are compression gaskets.

11. The device according to claim 9, wherein the first gaskets comprise steel.

12. The device according to claim 8, wherein the first gaskets are PFTE sealing rings.

13. The device according to claim 7, wherein the bushings are shrink-fitted onto the tubular channel.

14. The device according to claim 7, wherein the bushings are glued onto the tubular channel.

15. The device according to claim 14, wherein each bushing and/or the tubular channel comprises a grooved part.

16. The device according to claim 7, wherein each bushing comprises a threaded part adapted to mount the bushing to the first or second end wall.

17. The device according to claim 16, further comprising:
a second gasket is provided between each bushing and the first or second end wall.

18. The device according to claim 7, wherein each tubular channel is mounted to the first and second end walls by welding.

19. The device according to claim 5, wherein the box comprises a transformer transforming a low-voltage supply voltage into a high voltage for driving the coalescer elements.

20. The device according to claim 5, wherein the coalescer elements are energized from a power supply external to said box.

21. The device according to claim 5, wherein the box is filled with insulating oil.

22. The device according to claim 1, further comprising:
a layer provided on said tubular channel, said layer having low permittivity, being electrically insulating and being able to withstand a strong electric field.

23. The device according to claim 22, wherein said layer comprises PFTE.

24. The device according to claim 5, wherein the box is filled with SF₆.

25. The device according to claim 24, wherein the box is pressurized.

26. The device according to claim 21, wherein expansion bellows are installed in the box equalizing the pressures inside and outside said box.

27. The device according to claim 1, wherein the first end wall comprises a plurality of first openings each adapted to receive a first end of a tubular channel, and wherein the second end wall comprises a corresponding plurality of second openings each adapted to receive a second end of a tubular channel.

28. The device according to claim 1, wherein the tubular channel or channels are mounted substantially horizontal.
